(19) United States
(12) Patent Application Publication
(10) Pub. No.: US 2023/0419095 A1
(43) Pub. Date: Dec. 28, 2023

(54) METHOD FOR PROVIDING AN ARTIFICIAL NEURAL NETWORK

(71) Applicant: VOLKSWAGEN AKTIENGESELLSCHAFT, Wolfsburg (DE)

(72) Inventor: Heiko Gustav KURZ, Hannover (DE)

(21) Appl. No.: 18/254,043

(22) PCT Filed: Nov. 1, 2021
(86) PCT No.: PCT/EP2021/080287

§ 371 Date: May 23, 2023

(30) Foreign Application Priority Data
Nov. 27, 2020 (DE) 10 2020 214 907.0

(51) Int. Cl. G06N 3/067

(52) U.S. Cl. CPC G06N 3/0675

(57) ABSTRACT

A method for providing an artificial neural network which includes providing optical signal for the network to obtain an output of the network by processing the optical signal by the network and using a property of the optical signal which is specific to a spectral and/or temporal phase of the optical signal to provide at least one network component of the network for processing, wherein the at least one network component has at least one neuron and/or a weight of the network.

### PRIORITY CLAIM

This patent application is a U.S. National Phase of International Patent Application No. PCT/EP2021/080287, filed 1 Nov. 2021, which claims priority to German Patent Application No. 10 2020 214 907.0, filed 27 Nov. 2020, the disclosures of which are incorporated herein by reference in their entireties.

### SUMMARY

Illustrative embodiments relate to a method for providing an artificial neural network. Furthermore, illustrative embodiments relate to a system for this purpose.

### BRIEF DESCRIPTION OF THE DRAWINGS

Disclosed embodiments are described in detail with reference to the drawings. The features mentioned in the claims and in the description can be essential individually or in any combination. In the figures:

FIG. 1 schematically shows the operations of a disclosed method;

FIG. 2 schematically shows a neural network;

FIG. 3 schematically shows a graph of a sigmoid function which is used as a nonlinear function of a neuron;

FIG. 4 schematically shows an electrical field of a pulse as a function of time;

FIGS. 5a and 5b schematically show an electrical field strength of various laser pulses as a function of time;

FIGS. 6a and 6b schematically show a spectral phase of the optical signal as a function of time;

FIGS. 7a and 7b schematically show a GD and the spectral phase as a function of time;

FIGS. 8a-8c schematically show a dispersive element for use as a neuron;

FIGS. 9a-9c schematically show a visualization of a propagation of a laser pulse through a quartz glass and the reflection by a dispersive minor as a dispersive element;

FIGS. 10a-10d schematically show a visualization of a GD and GDD of a laser pulse after propagation through a quartz glass and the reflection by dispersive, dielectric thin layers as a dispersive element;

FIGS. 11a-11e schematically show a profile of a spectrum and the spectral phase of the optical signal during the processing by the network by a dispersive element;

FIGS. 12a-12d schematically show profiles of a spectrum and the spectral phase of the optical signal during the processing by the network by a dispersive element;

FIG. 13 schematically shows an exemplary formation of a dispersive, optical network;

FIG. 14 schematically shows an exemplary embodiment of a spectral phase analyzer, in which two time-delayed pulses are mixed in a nonlinear process with a time stretched pulse, so that the frequency-converted output pulses are spectrally sheared;

FIG. 15 schematically shows a flow chart of the data processing by the optical network;

FIGS. 16a-16c schematically show a propagation of a laser pulse through quartz glass and reflection by a dispersive mirror;

FIGS. 17a and 17b schematically show a propagation of a laser pulse through quartz glass and reflection by different dispersive minors; and

FIG. 18 schematically shows an exemplary formation of the neural network by a semiconductor.

### DETAILED DESCRIPTION

There are many possible applications for the use of artificial neural networks, which are dependent on rapid processing of the items of information. For example, for automatic driving the most secure possible surroundings perception in real time is of great importance. The surroundings of a transportation vehicle can be acquired with the aid of sensors, such as radar, lidar, and camera. Integrated 360° 3D acquisition of the environment can often also be provided, so that all static and dynamic objects are acquired and classified.

In particular, the camera has a leading role in a redundant, robust surroundings acquisition, since this sensor type can measure angles precisely in the surroundings acquisition and can be used for classification of the surroundings. However, the processing and classification of the camera images is computing-intensive and architectonically complex. In particular, the 360° 3D surroundings acquisition is problematic, since many individual images have to be classified and processed and therefore the computing effort increases.

Conventional high-performance artificial neural networks (called NN or ANN) offer the possibility of classifying camera images or data of other sensors having image repetition rates of less than 10 Hz. For many applications, such as in secure surroundings acquisition in real-time, this image repetition rate is often inadequate, because modern camera systems operate at 30 Hz image repetition rate. In addition, the data load increases with increasing resolution of the camera images.

The often limiting factor is the processor speed or GPU speed of modern high-performance computers, which can, even with GPU acceleration, not be adequate to classify the images completely in real-time.

Disclosed embodiments at least partially remedy the above-described drawbacks. Disclosed embodiments propose an alternative to conventional ANNs.

The above is achieved by a method and by a system disclosed in the following description, and the drawings. Features and details which are described in conjunction with the disclosed method obviously also apply in conjunction with the disclosed system, and vice versa in each case, so that reference is always mutually made or can be made with respect to the disclosure of the individual facets of the disclosure.

Disclosed is a method for providing an artificial neural network, in particular, an optical, dispersive neural network. It is provided in this case that the following operations are carried out, optionally in succession in the specified sequence and/or repeatedly:
providing an optical signal for the network to obtain an output of the network by processing of the optical signal by the network, wherein optionally the processing of the optical signal by the network is carried out by a predefined optical filtering of the signal,
using a property of the optical signal, wherein the property can be specific for a (spectral and/or temporal) phase of the optical signal, to provide at least one network component of the network for the processing, wherein optionally the at least one network component comprises at least one neuron and/or at least one weight of the network, wherein optionally the use of the property takes place in that the predefined optical filtering comprises a predefined adaptation of the property to provide a linear weighting and/or nonlinear function of the neuron,
optionally: providing multiple neurons as the at least one network component and using a spectral combiner of the network to spectrally combine the output signals of the neurons obtained by the use of the property.

In this way, optical processing of the signal can be enabled, and can thus provide significant speed benefits over solely electronic processing. The processing and filtering can be predefined here, thus the extent of the change of the property for the processing (for example, in the context of a training phase) can be permanently specified during the creation of the network. This can be carried out, for example, structurally by the selection and/or adaptation of optical elements of the network for the use of the property and/or filtering of the optical signal.

The use of the property of the optical signal which is specific for the (spectral and/or temporal) phase of the optical signal to provide the neuron and/or the weight can take place, for example, in that the dispersion of the optical signal during the propagation in material is used as the neuron and/or weight. The at least one neuron of the artificial neural network (designated in short as ANN) can be embodied in each case, for example, as an optical and/or dispersive neuron and/or the at least one weight of the ANN can be embodied in each case as an optical and/or dispersive weight. In this way, processing of items of information (in particular, data) at light speed is possible.

For example, the optical signal comprises an optical input signal, which is input into the network. The items of information to be processed can be represented by the input signal, which are processed by the processing of the optical input signal, to obtain the output (for example, as an optical output signal, thus of the processed optical input signal) as a result of the processing.

One possibility for providing the optical signal is to use laser pulses as the optical signal (i.e., light signal). Nevertheless, alternative exemplary embodiments of the optical signal are also conceivable, for example, as a continuous laser beam or the like. The processing can be carried out by a change of the (spectral and/or temporal) phase profile, as will be described by way of example hereinafter. For this purpose, an optical, dispersive element can be used, which is suitable for adapting the (spectral and/or temporal) phase profile. The change of the (spectral and/or temporal) phase profile enables the property of the optical signal, which is specific for the (spectral and/or temporal) phase of the optical signal, such as the (spectral and/or temporal) phase itself or its derivative or its Fourier transform, to be able to be used as the optical neuron and/or as the optical weight.

Furthermore, it is conceivable in the scope of the disclosure that the provision of the optical signal takes place in that a light signal is transmitted into at least one of the at least one network component, wherein the light signal can be a carrier of an item of information which is processed by the processing of the network to obtain an assessment, in particular, a classification, of the information as the output. The optical signal can thus initially be input as an input signal into the network. In this way, items of information can be input into the network, for example, sensor data or the like. The items of information can also be transmitted here directly as the input signal (for example, light via an optical unit or LiDAR radiation) and/or the items of information can be read in electronically and then transmitted on an optical carrier signal as the input signal. (LiDAR is in this case an abbreviation for light detection and ranging, and can be used, for example, in a transportation vehicle for acquiring the surroundings and/or for distance and velocity measurement.)

It can be provided in the disclosed embodiments that the use of the property specific for the (spectral and/or temporal) phase of the optical signal takes place in that a (spectral and/or temporal) phase profile of the optical signal is changed nonlinearly and/or linearly to change the property (in particular, in a predefined manner), in particular, to execute a nonlinear function of the neuron (such as an activation function) and/or a linear weighting of the weight. Generally formulated, the use of the property of the optical signal is carried out, for example, by the use of the (spectral and/or temporal) phase or a property dependent thereon. The property (specific for the spectral and/or temporal phase of the optical signal) can accordingly be the spectral and/or temporal phase itself or also a group delay (abbreviated GD) or a group delay dispersion (abbreviated GDD) or a group velocity dispersion (abbreviated GVD) or a third order (abbreviated TOD) or higher order dispersion of the derivative of the spectral phase. To carry out the processing by way of the network and specifically by way of the network component, thus, for example, to execute a weighting by the weight and/or a function of the neuron (for example, an activation function), the above-mentioned property can be changed (for example, by using dispersive materials). The optical, dispersive elements described hereinafter are used for this purpose, for example, which can be structurally assembled to form the network to provide the processing. In the weighting, for example, a linear change of the dispersion and/or the spectral and/or temporal phase and/or the GD and/or the GDD and/or the TOD takes place. A frequency modulation of the optical signal can possibly also be carried out for the weighting. Furthermore, it is conceivable that to execute the (nonlinear) function of the neuron, a nonlinear change of the property, for example, of the spectral phase and/or the GD and/or the GDD and/or the TOD, is carried out. The function of the neuron can thus be provided, for example, as an activation function such as a Heaviside function or sigmoid function or RELU function.

It can be provided in the scope of the disclosure that the output and/or an output signal of the at least one network component is evaluated in that the property of the optical signal specific for the (spectral and/or temporal) phase of the optical signal is evaluated, in particular, measured. To carry out the processing by way of multiple weights and/or neurons, thus to combine the network components with one another (i.e., optionally to couple them with one another), a coherent or incoherent spectral combination of the optical (output) signal of multiple neurons can be provided, and the combined (output) signals can be passed on via optical weights to adjoining optical neurons of the next layer. Finally, the property specific for the (spectral and/or temporal) phase of the optical signal can be measured to evaluate the output of the network. Accordingly, the dispersion profile can be detected at the output of the network as the desired output information, for example, class information in the case of a classification, and the output can be passed on, for example, to a CPU (central processing unit) or GPU (graphics processing unit) for further processing such as a formation of a surroundings model.

The disclosed method can provide the benefit that the computing speed for the processing is increased by the ANN, and the creation of deeper optical neural ANNs is also enabled. The classification can take place at light speed here. Furthermore, lower optical performances can be necessary in relation to alternative solutions, to trigger a nonlinear response function, since no multiphoton processes have to participate or only material properties can be used. Furthermore, a ring line can be implementable easily. The entire ANN can be able to be physically manufactured as an optical neural network (abbreviated ONN) on a semiconductor. Furthermore, an integration of the ONN on a semiconductor chip can be possible in CMOS, SiN-CMOS, Bi-CMOS, hybrid Bi-CMOS processes on photonic-electronic cointegrated chips.

Furthermore, it can be provided in the scope of the disclosure that the optical signal is provided as an optical input signal which is specific for an item of input information, and is processed by the at least one network component to obtain an optical output signal specific for the output. The output signal can therefore, in contrast to the input signal, comprise an additional item of information about the input signal, for example, an item of class information of a classification.

It can further be provided that multiple network components are provided which comprise neurons and/or weights which are provided with one another in different levels of the network and are optically connected to one another. The network can typically be composed of multiple network components which are connected to one another in accordance with the network structure. The network components can be provided here in different levels of the network, and the output signals of the network components of one level can be transmitted to the network components of a following level as an input signal via connections such as optical fibers.

It can optionally be provided that the property specific for the (spectral and/or temporal) phase of the optical signal is the spectral and/or temporal phase itself or a group delay or a group delay dispersion or a group velocity dispersion or a third order or higher order dispersion of the derivative of the spectral phase. This enables reliable processing and evaluation of the optical signal. It can furthermore be possible that the neuron is embodied as a dispersive neuron which provides the nonlinear function of the neuron by way of a spectral phase modulation of the optical signal.

According to a further benefit, it can be provided that the network is used in a transportation vehicle, wherein optionally the optical signal is provided as an optical input signal which is specific for an item of input information about the surroundings of the transportation vehicle, and is processed by the at least one network component to optionally obtain the output as a classification of the input information. The transportation vehicle can be designed, for example, as a motor vehicle and/or passenger motor vehicle (or utility motor vehicle) and/or autonomous vehicle. The input information is, for example, a signal having the sensor data of a camera or the like.

A system for providing an artificial neural network, optionally for a transportation vehicle, is also the subject matter of the disclosure, including:
an (in particular, electro-optical) interface for providing an optical signal for the network to obtain an output of the network via processing of the optical signal by the network,
at least one optical and/or dispersive element for a use of a property of the optical signal which is specific for a spectral and/or temporal phase of the optical signal to provide at least one network component of the network for the processing.

It is provided in this case that the at least one network component comprises at least one neuron and/or one weight of the network. The disclosed method can therefore provide an ANN in an optical, dispersive manner.

The disclosed system is thus accompanied by the same benefits as have been described in detail with reference to a disclosed method. Moreover, the system can be suitable for executing a disclosed method.

A plurality of the elements can be provided in the disclosed system and can be structurally coupled with one another to form the network. For example, for this purpose an integration of the elements into a semiconductor and/or a coupling by optical fibers takes place to transmit the optical signal between the network components. The dispersive element can include, for example, a dispersive medium to carry out the use, in particular, the change, of the property of the optical signal.

In addition, it can be beneficial in the scope of the disclosure that multiple optical elements are provided and are each embodied to change a spectral and/or temporal phase profile of the optical signal at least nonlinearly (or alternatively or additionally linearly) for the use of the property, in each case to provide an output signal of a neuron (alternatively or additionally a weight) of the network, wherein optionally at least one spectral combiner of the network is provided to spectrally combine the output signals of the neurons (or weights), and optionally a spectral phase analyzer is provided to evaluate a phase of the combined output signal for the provision of the output.

In the following figures, identical reference signs are used for the same technical features, even of different exemplary embodiments.

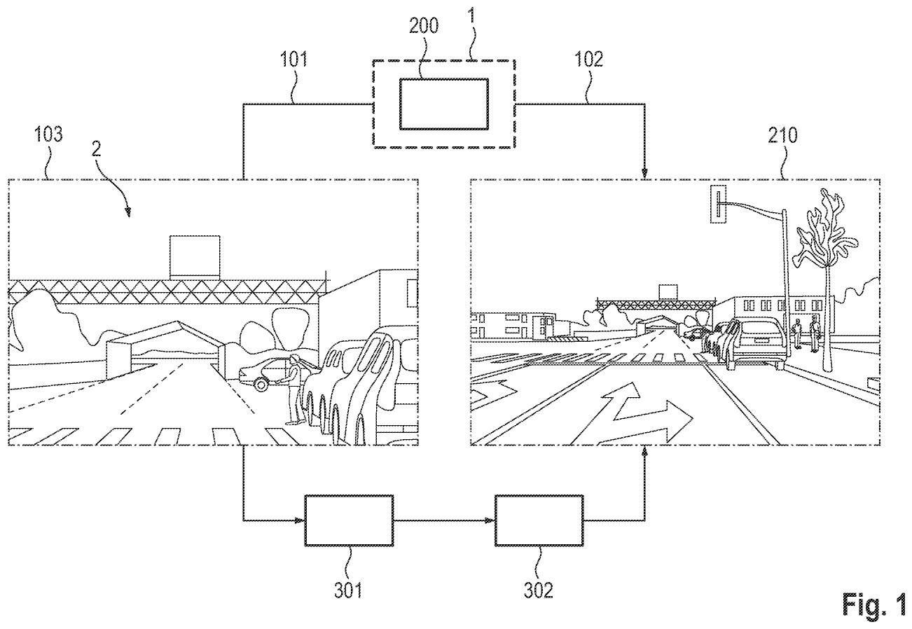

The operations of a disclosed method for providing an artificial neural network 200 are schematically visualized in FIG. 1. According to a first method operation at 301, a provision of an optical signal 100 (shown for illustration as an input signal 101 and an output signal 102) for the network 200 takes place to obtain an output 210 of the network 200 by processing of the optical signal 100 by the network 200. The input signal 101 can be provided, for example, on the basis of sensor data 103 such as of a camera image. Subsequently, according to a second method operation at 302, a use of a property of the optical signal 100 can take place, wherein the property is specific for a spectral and/or temporal phase of the optical signal 100, to provide at least one network component 250 of the network 200 for the processing. As also described in more detail hereinafter, the at least one network component 250 can comprise a neuron 251 and/or a weight 252 of the network 200.

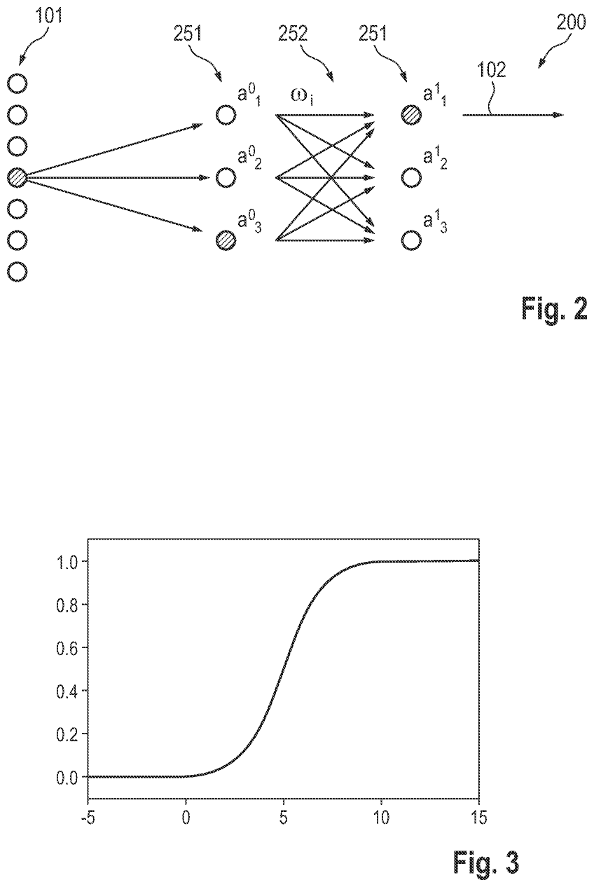

As is further illustrated in FIG. 1, the ANN 200 can be used, for example, in an automatic driving function of a transportation vehicle 1 for classifying the surroundings 2 of the transportation vehicle 1. Generally formulated, it can be provided that the network 200 is used in a transportation vehicle 1, wherein the optical signal 100 is provided as an optical input signal 101, which is specific for an item of input information about the surroundings 2 of the transportation vehicle 1, and is processed by the at least one network component 250 to obtain the output 210 as a classification of the input information. The input information can be ascertained, for example, by a camera of the transportation vehicle 1. Sensor data 103, such as a camera image of the camera, can be converted into the optical input signal 101 and passed on via a weighting 252 (weights) to the neurons 251 of the ANN 200 (schematically shown in FIG. 2). During the processing by the ANN 200, for example, a class is assigned to the individual pixels of the camera image (for example, to distinguish the roadway from roadway markings, transportation vehicles and pedestrians or vegetation can also be separate classes). The classification can be represented by the output 210. The surroundings 2 can be precisely acquired by this classification, and the output 210 can thus contribute to the scene understanding, so that the driving function can act adaptively.

The output signal of the neurons 251, and thus the signal passed on to the neurons 251 of the following layer, can be given here by a sigmoid function of the sum of weighted response functions

α₁¹=σ(Σωᵢαᵢ⁰) (1)

wherein ωᵢ represents the weights 252, αᵢ⁰ represents the neurons 251, and a represents the sigmoid function (see FIG. 3, in which an exemplary graph of a sigmoid function is shown), which is often used as a nonlinear function of a neuron within an ANN 200. The ANN 200 thus forms a function

f(α⁰, . . . ,αⁿ)=(y₀, . . . ,yₖ) (2)

with k, n∈ [symbol] , and wherein the function values yᵢ can be output as the class information of the output 210.

Artificial neural networks are typically implemented on conventional computer architectures, which have the drawback of the slow processing of large amounts of data, however. In contrast, a significant speed benefit can be achieved by the optical design of the ANN 200, which also enables the use of the ANN 200 for driving functions, for example, also of autonomous driving.

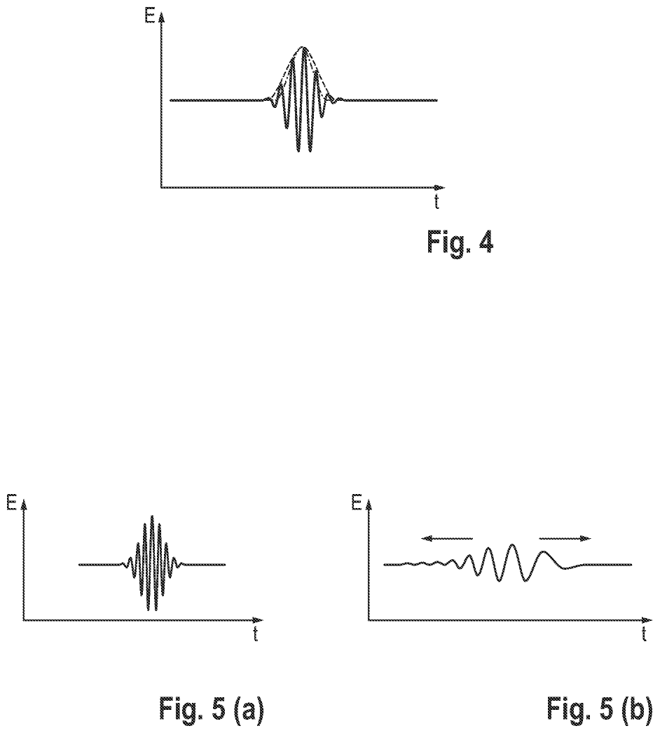

For example, continuous laser beams (i.e., continuous wave, thus a wave emitted continuously over time) or laser pulses come into consideration as the optical signal 100, which may be transmitted in a technically reliable manner via optical fibers 283 to the at least one network component 250. FIG. 4 shows a schematic representation of a single laser pulse as a function of time t, in which the electrical field E of the pulse oscillates under the envelope curve. The individual pulse is characterized here by its duration T, the wavelength λ/frequency ω, and the amplitude. The minimum achievable chronological duration of such a pulse is defined by the time-bandwidth product:

τ·Δω=const. (3)

It can be inferred from equation (3) that the pulse has a spectral bandwidth and accordingly is a superposition of monochromatic waves of various frequencies. As shown in FIG. 5 in diagram (a), a single frequency therefore does not merely oscillate under the envelope, but rather multiple spectral modes.

The velocity of the movement of the envelope is called group velocity υ_{g} (or also designated in short as GV) and is defined via the derivative of the wave number k (of the wave vector):

$$\frac{\partial k}{\partial ω} = \frac{1}{{υ}_{g}} = \frac{1}{c} ( n ( ω ) + ω \cdot \frac{\partial n ( ω )}{\partial ω} ) \qquad ( 4 )$$

The index of refraction is given here by n(ω). The propagation velocity of the individual monochromatic waves is designated as the phase velocity υₚ:

$${υ}_{p} = {c}_{n} = \frac{ω}{{k}_{n}} \qquad ( 5 )$$

wherein the wave number is given with

$${k}_{n} = \frac{2 π \cdot n ( ω )}{λ} = \frac{ω \cdot n ( ω )}{c} \qquad ( 6 )$$

If the pulse propagates in a dispersion-free manner, υ_{g} and υₚ are thus identical since

$$\frac{\partial n ( ω )}{\partial ω} = 0$$

(see FIG. 5 according to diagram (a) shown therein). However, this is not the case within a dispersive medium, so that the profile of the envelope changes (see FIG. 5 according to diagram (b) shown therein). It can be inferred from equations (4) and (5) that within a normal dispersive medium (n>1), the red spectral component is delayed less strongly than the blue spectral component, by which the pulse is time stretched (frequency chirp).
By solving the Helmholtz equation, the electrical field of a laser pulse E(t) can be described as a function of time t by

$$E ( t ) ∝ \frac{1}{2} \sqrt{I ( t )} \cdot {e}^{i {ω}_{0} t} \cdot {e}^{- i ψ ( t )} + c . c . \qquad ( 7 )$$

wherein ω₀ describes the carrier frequency, ψ(t) describes the temporal phase, and I(t) describes the intensity. For Gaussian pulses, for example, I(t) is given by

I(t)∝|E₀|²·e^{-2.76·t/τ} (8)

with the amplitude of the electrical field E 0 and the full width at half maximum of the pulse τ, which defines the pulse duration. It is apparent from equations (7) and (8) that not only amplitude, frequency, and pulse duration are sufficient for the complete characterization of the pulse, but rather the temporal phase also has to be considered. A spectral observation of the pulse suggests itself for more insight into the dispersive dynamics within the pulse.

By way of Fourier transform of E(t) in the frequency space, the following results from equation (7) with centering of the pulse around its central frequency (ω−ω₀)→ω:

\tilde{E}(ω)∝\sqrt{S(ω)}·e^{ik}^{ₙ}^{(ω)zt}=\sqrt{S(ω)}·e^{iϕ(ω)t} (9)

Therein, S(ω) represents the spectral power density and ϕ(ω) represents the spectral phase, which can be expressed by

$$ϕ ( ω ) = {k}_{n} ( ω ) \cdot z = \frac{n ( ω ) \cdot ω \cdot z}{c} = - Im \{ ln [ \tilde{E} ( ω ) ] \} \qquad ( 10 )$$

The spectral phase defines the phase relationship of the individual monochromatic waves under the envelope.

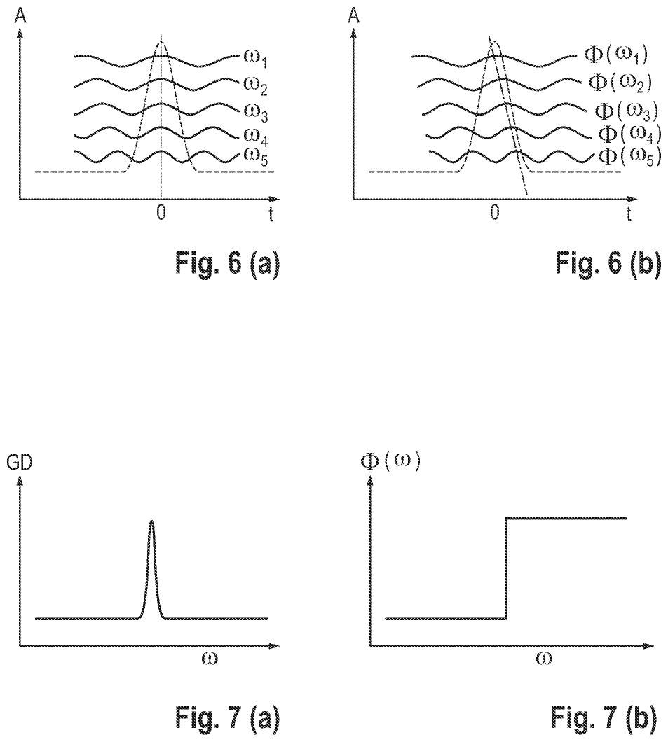

Different oscillating frequencies ωᵢ are schematically shown in illustration (a) in FIG. 6, which oscillate in phase under the envelope of the pulse. According to illustration (b), the maxima of the individual frequencies are phase-shifted. The spectral phase is shown in each case as a function of time t. All spectral components are in phase for ϕ(ω)=0, so that constructive interference takes place and the pulse forms a sharp maximum at t=0. In contrast, a linear phase relationship ϕ(ω)=αω corresponds to a time offset, so that no intensity maximum is formed at t=0 (see FIG. 6 (b)).

It is clear from equations (9) and (10) that dispersion by the index of refraction has significant influence on the spectral phase and thus the chronological intensity curve of the pulse. However, the pulse can be completely characterized by measuring the spectrum and the spectral phase. The derivatives of the spectral phase, such as group delay (GD):

$$G D = \frac{\partial ϕ}{\partial ω} = \frac{\partial }{\partial ω} [ \frac{ω \cdot n}{c} \cdot z ] = z \cdot \frac{\partial {k}_{n}}{\partial ω} = \frac{z}{{υ}_{g}} , \qquad ( 11 )$$

group delay dispersion (GDD):

$$GDD = \frac{{\partial }^{2} ϕ}{\partial {ω}^{2}} = z \cdot \frac{{\partial }^{2} {k}_{n}}{\partial {ω}^{2}} , \qquad ( 12 )$$

third order dispersion (TOD):

$$TOD = \frac{{\partial }^{3} ϕ}{\partial {ω}^{3}} = z \cdot \frac{{\partial }^{3} {k}_{n}}{\partial {ω}^{3}} , \qquad ( 13 )$$

and the like have great influence on the pulse dynamics and are variables that can be metrologically acquired to describe the interaction of laser pulses with material. During the propagation of a laser pulse through material, the dispersion can be described by the accumulation of a spectral phase. Short pulses may thus be time-chirped by accumulation of a spectral phase profile. Vice versa, however, chirped pulses can also be compressed in time by the accumulation of a negative phase contribution.

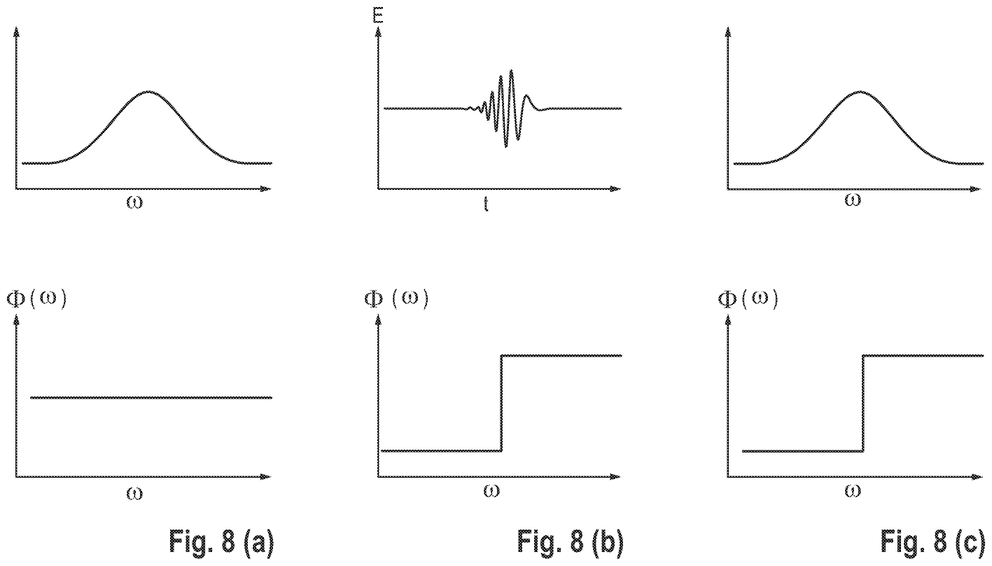

A possibility for using the spectral phase ϕ(ω) as a neuron 251 for the ANN 200 is to be described by way of example hereinafter. For artificial neurons 251, the nonlinear response function is essential. The sigmoid function is often used here in conventional ANNs (see FIG. 3). The spectral phase profile of an optical light signal, such as a laser pulse, can be modulated in the same manner to map a nonlinear phase profile. FIG. 7 illustrates, in illustration (a), schematically and by way of example the profile of the GD as a Delta function. By integration of the GD, the spectral phase extends as a Heaviside function, which can be desirable for the use as an optical neuron 251 (see FIG. 8 according to illustration (b)).

Effects of the spectral light-material interaction, such as propagation of laser pulses in dispersive media, offer the possibility of modulating an incident light wave nonlinearly in its spectral phase, comparable to the nonlinear modulation of the electric current by an artificial neuron. A dispersive material can act as an optical neuron 251, which outputs an item of nonlinear phase information. FIG. 8 shows the functionality of a dispersive neuron 251. An incident light signal has a flat phase profile (FIG. 8 (a)). During the interaction with a dispersive element, the pulse accumulates a spectral phase (see FIG. 8 (b)). The resulting output spectrum is identical to the input spectrum, but the spectral phase has a nonlinear profile (FIG. 8 (c)).

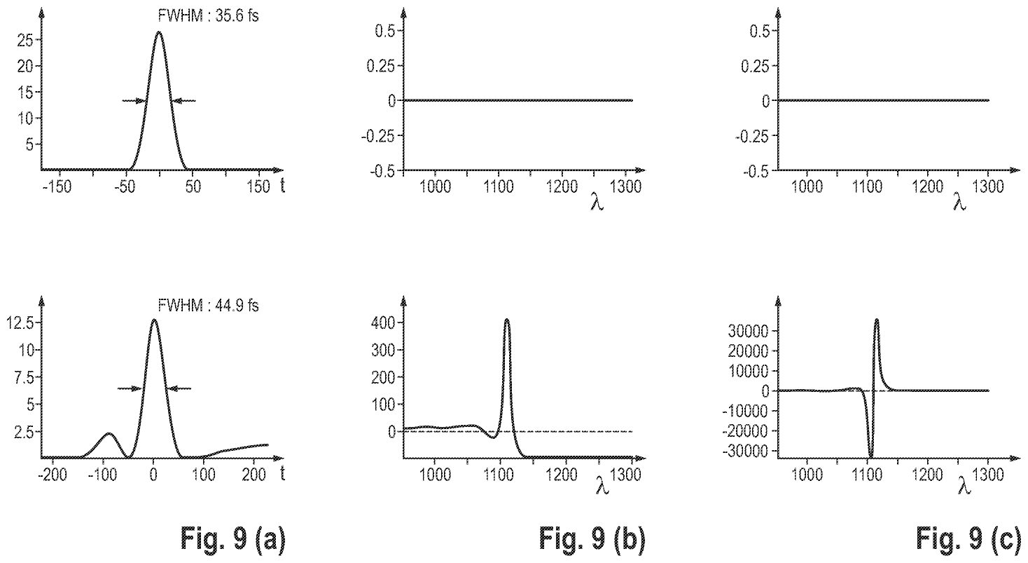

FIG. 9 shows a simulation of the propagation of a laser pulse before and after propagation through 3 mm quartz glass and subsequent interaction with a dielectric, dispersive layer, for example, a chirped mirror. The chronological intensity profile is changed by the light-material interaction (see FIG. 9 (a)). The spectral profile of the GD has the desired profile of a Delta function, however, which corresponds to a Heaviside-shaped profile of the spectral phase (cf. FIG. 7). By reading out the spectral phase, this information can thus be used as the neuron 251. Alternatively, the GD, the GDD, the TOD, or higher orders of the dispersion can be directly used as a neuron. FIG. 9 (a) shows the profile of the pulse over time t, FIG. 9 (b) shows the profile of the GD, and FIG. 9 (c) shows the profile of the GDD, each over the wavelength λ.

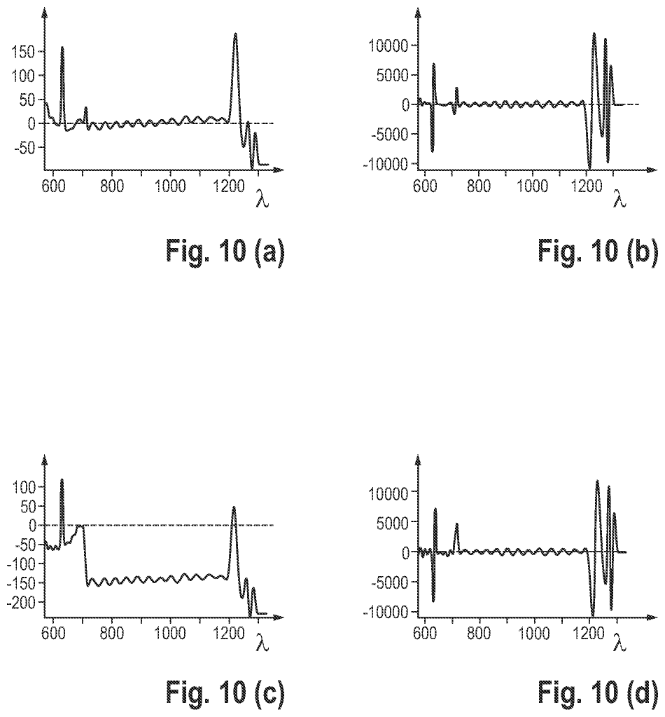

FIG. 10 shows, according to illustration (a) and (c), the simulation of the GD and, according to illustration (b) and (d), the GDD of a laser pulse after propagation through 3 mm quartz glass and subsequent reflection by dispersive, dielectric thin layers. The profile of the GD as a function of the wavelength has minor oscillations. These oscillations can be reduced by optimizing the dielectric, dispersive layers. The incorporation of a special dielectric layer has the result that the pulse collects more spectral phase and therefore the GD in the spectral range from 700 nm to 1100 nm is linearly reduced to −150 fs. The interaction with these layers therefore acts like a subtraction of the absolute value of the GD and corresponds to a linear change of the spectral phase. Operations such as addition, subtraction, multiplication, and division can thus be carried out by dispersive elements 230 and enable the use of these elements 230 as weights 252 for ANNs.

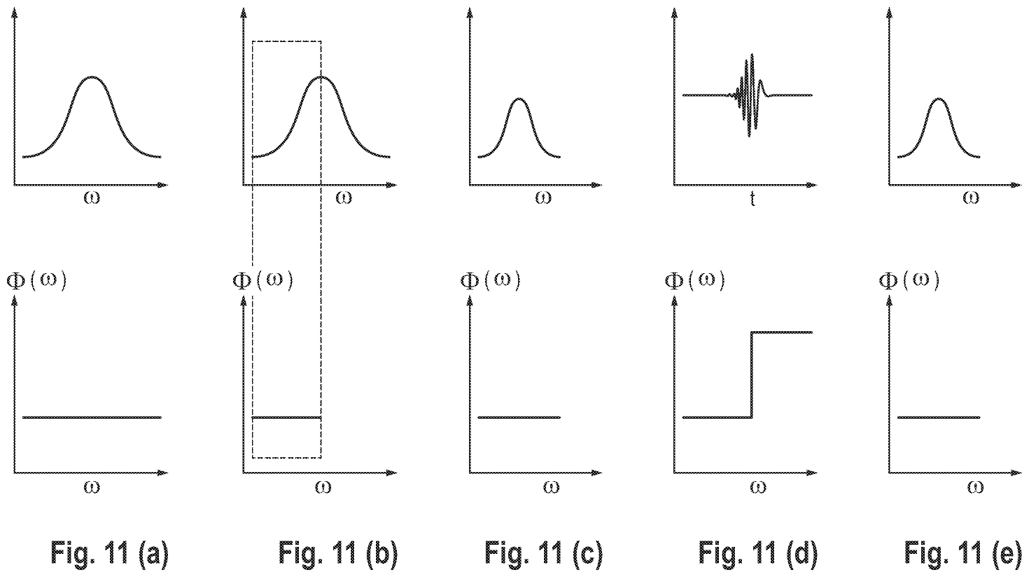

FIG. 11 schematically represents the linear modulation of the spectral phase. A spectral filter is used therein to reduce the spectral bandwidth of the input signal. The resulting spectrum after filtering has a lower bandwidth. This modulation corresponds to a subtraction operation and influences the subsequent interaction with a dispersive neuron 251, so that the nonlinear response of the neuron 251 is not triggered and the phase profile at the output is linear. Illustration (a) in FIG. 11 indicates the input spectrum, which interacts with a spectral filter according to illustration (b), wherein the spectral bandwidth is changed, but not the spectral phase profile (illustration (c)). After the interaction with a dispersive element 230 (illustration (d)), the spectral phase is linearly modulated, which corresponds to a weighting. Illustration (e) shows the resulting spectrum or the resulting phase.

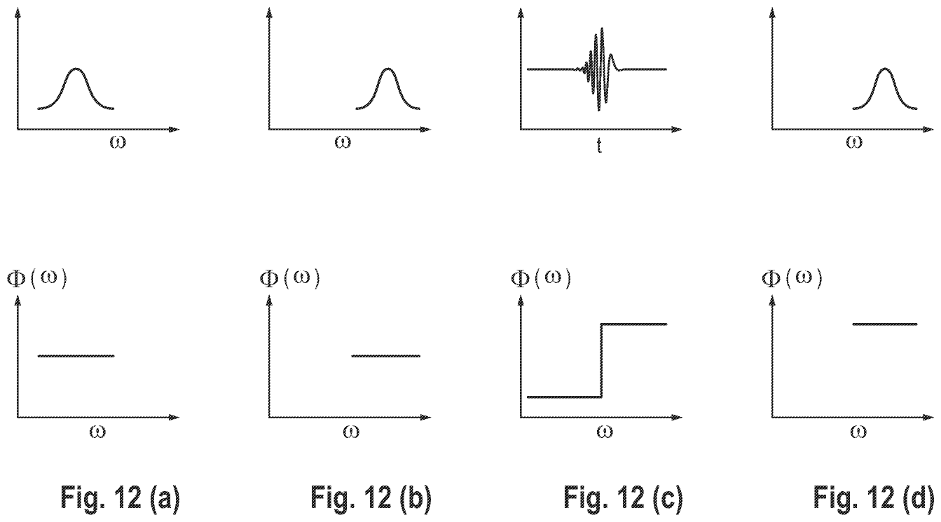

FIG. 12 represents, analogously to FIG. 11, an optical weighting by a frequency shift. The spectral phase is multiplied by a constant factor by spectral shift of the input spectrum and subsequent interaction with a dispersive element 230.

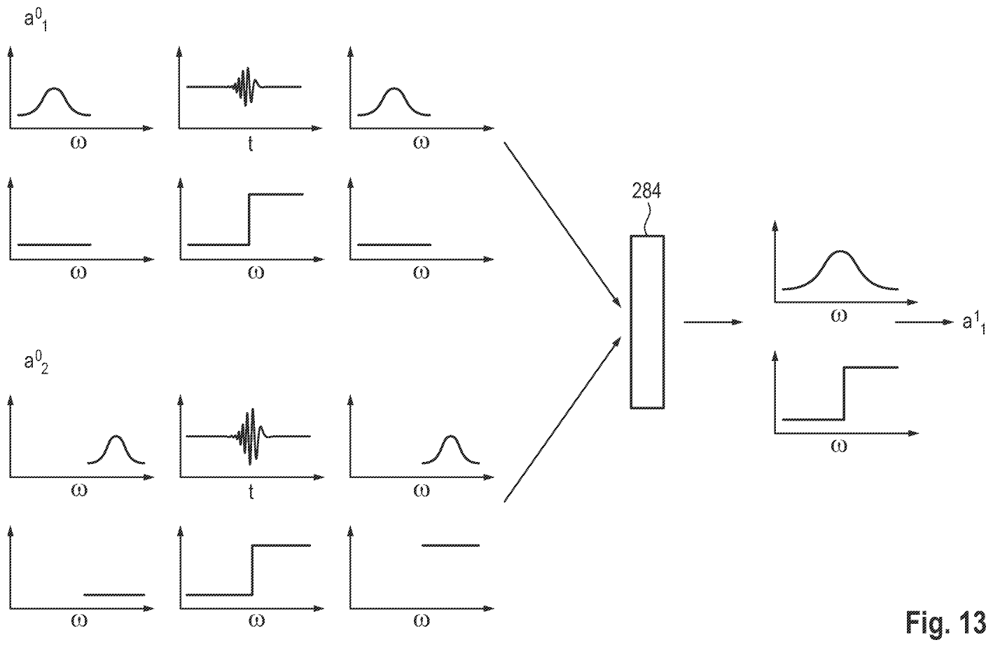

To form an ANN 200, the optical signal 100 of the individual neurons 251 has to be passed on via a weighting 252 to all neurons 251 of the next layer. One possibility for spectrally joining together the output signals of the neurons 251 is formed by optical spectral combiners 284, in particular phase combiners 284. Optical gratings and/or prism sequences and/or dielectric layers and/or optical nonlinear media and/or polarization optics or the like can be used as such a component, for example. The spectral phase can be combined coherently or incoherently here. FIG. 13 schematically represents the spectral combination of two neurons 251. The output signal of the individual optical neurons anm is spectrally combined by an optical component. The profile of the spectral phase as a function of the frequency of both individual neurons 251 is provided as the output signal of the spectral combiner and can be passed on to the closest neuron 251 via a weight 252. A dispersive optical neural network (dONN) is thus formed.

To carry out a classification, it can be necessary for the spectral phase or its derivatives to be measured. Diverse established methods are available for this purpose.

For example, the interference signal of two optical pulses can be measured by spectral interferometry by the use of a spectrometer, wherein one of the two pulses is delayed by a time τ and the spectral phase of the pulse is known. The combined signal of both pulses at the spectrometer can be described by

\tilde{E}(ω)=\tilde{E}₁(ω)+\tilde{E}₂(ω)e^{-iωτ} (14)

For the oscillating term, the following phase relationship results

ϕ(ω)=ωτ+ϕ₁(ω)−ϕ₂(ω). (15)

With known spectral phase of the reference pulse, the spectral phase can be reconstructed from the spectral interferogram and the spectrometer can thus be used for a spectral phase analyzer 285.

According to a further option, a heterodyne detector for characterizing the spectral phase can be used as a spectral phase analyzer 285.

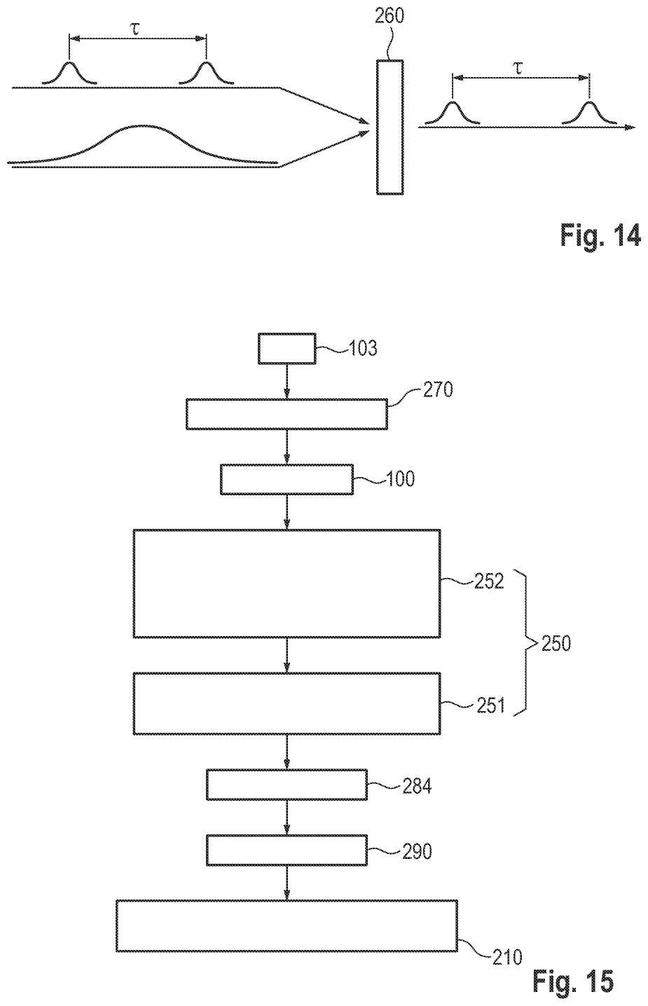

A further option is the use of a spectral shearing by a spectral phase analyzer 285. In this case, two time-delayed pulses are overlaid with a chirped replica pulse in a nonlinear crystal 260 of the spectral phase analyzer 285 (see FIG. 14). The time-delayed pulses experience spectral shearing due to frequency conversion in the crystal 260. The GD can be extracted directly from the spectral interferogram:

GD=ϕ(ω+Ω)−ϕ(ω) (17)

with the spectral shearing Ω, which is proportional to the time delay of the pulses τ. The spectral phase results as:

$$ϕ ( ω ) \approx \frac{1}{Ω} \int GDd ω \qquad ( 18 )$$

In a FROG structure of a spectral phase analyzer 285, two pulses time-delayed in relation to one another can be overlaid in a nonlinear crystal 260. The frequencies newly generated in this case are recorded by a spectrometer of the spectral phase analyzer 285. The interferogram results as a function of the frequency and the time delay of both fundamental pulses and the spectral phase can be reconstructed.

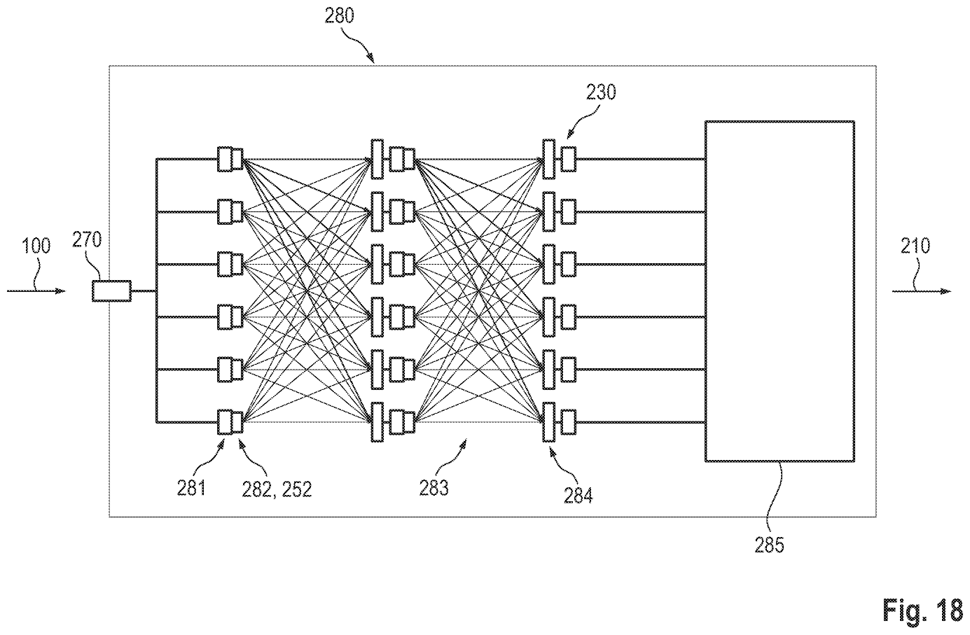

A complete dONN can be implemented, for example, by joining together at least one of the above-described elements 230. This is visualized by way of example in FIG. 15. A dispersive element 230 for forming an optical neuron 251 by spectral phase modulation comes into consideration in this case as the at least one element 230. An element 230 for providing a linear modulation of the spectral phase can also be used as the at least one element 230 for forming an optical weight 252. Furthermore, the at least one element 230 can comprise a spectral combiner 284, which is designed to carry out a coherent or incoherent spectral combination of the signal of the dispersive neurons. Furthermore, the at least one element 230 can comprise a spectral phase analyzer 285, thus an element 230 for measuring the spectral phase profile. FIG. 15 furthermore shows that the electro-optical data processing is enabled by an interface 270 to convert the sensor data 103 into the optical signal 100. The sensor data 103 can be transmitted here, for example, on an optical carrier via optical fibers 283 (shown in FIG. 18) to the network components 250 of different levels 290.

Further exemplary embodiments of, in particular, optical, elements 230 for providing the network components 250 are described hereinafter. A temporal phase can thus be applied to the pulse by an electro-optical modulator as the element 230, such as a Mach-Zehnder modulator (MZM). This is equivalent to a spectral phase in the frequency space. Optical weights 252 can thus be synthesized by linear modulation by the MZM and optical neurons 251 can be synthesized by nonlinear modulation of the MZM.

Furthermore, it can be possible that so-called pulse shapers are used as the element 230, which can apply a temporal phase on the basis of LCDs or electronic index of refraction change.

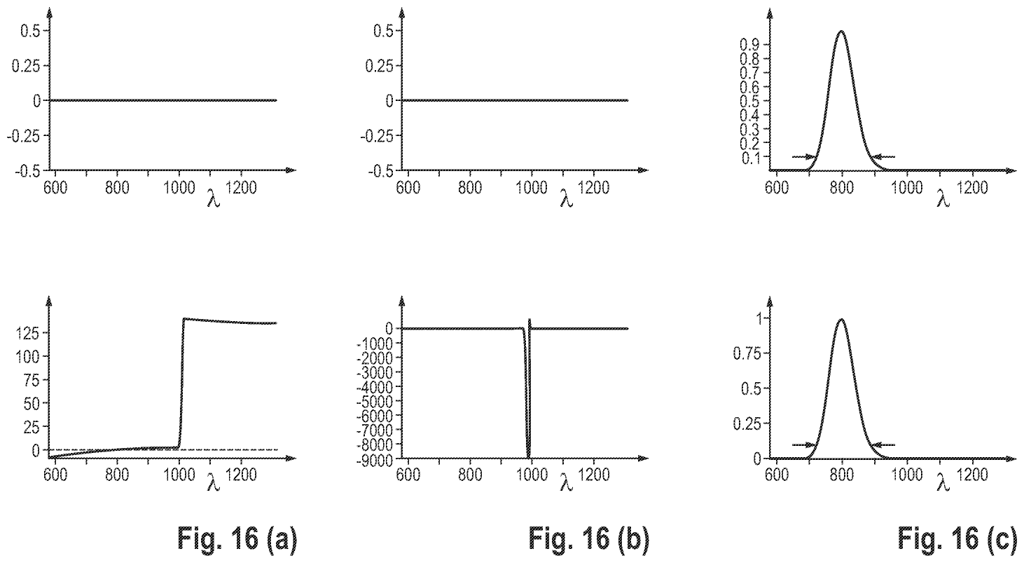

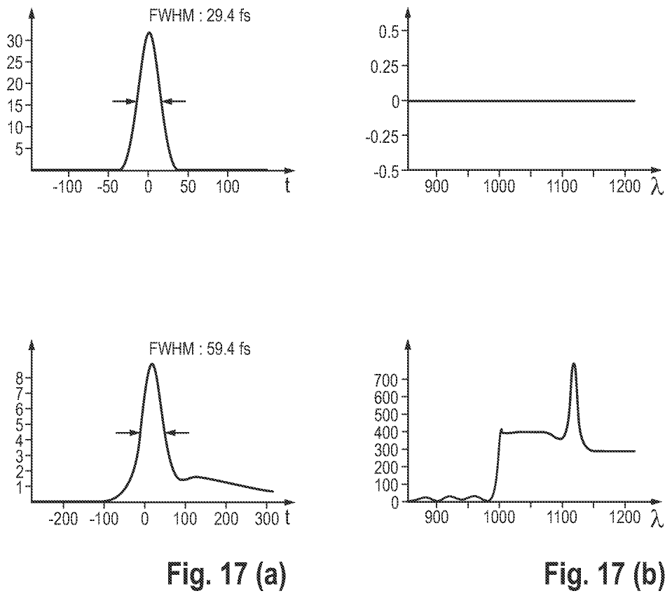

A further possibility for providing a network component 250 is the use of the GD as a response function of the neuron (see FIG. 16, wherein according to illustration (a) GD before and after the propagation is shown and according to illustration (b) GDD before and after the propagation is shown, illustration (c) shows the spectral power density) and weight (see FIG. 17, wherein according to illustration (a) the chronological intensity profile before and after the propagation is shown and according to illustration (b) GD before and after propagation is shown).

To provide a network component 250, it is also possible to use the GDD as a nonlinear function of the neuron 251 and weight 252 or to use higher orders of the dispersion, such as TOD or the like.

A further possibility for providing a network component 250 is to focus an intensive pulse of lower bandwidth in an optical nonlinear medium as the element 230. The pulse can experience an enlargement of the spectral bandwidth by self-phase modulation (SPM) and is passed on into the optical neuron 251. The spectral phase experiences a nonlinear modulation due to the increased bandwidth. The SPM is used here, for example, as an optical weight. Vice versa, spectral filters can prevent the triggering of the neuron.

Furthermore, the integration of the above-described components on a semiconductor 280, in particular, an electronic-photonic cointegrated chip in CMOS, bi-CMOS, bybrid bi-CMOS, Si—N CMOS process or the like, is conceivable to provide the at least one network component 250 or the network 200. FIG. 18 shows by way of example that the optical signal 100 can be optically coupled into the network 200 via an interface 270. Furthermore, dispersive layers 281 can be provided, in which the network components 250 are provided. For example, a linear frequency modulator 282 can be used for the weighting 252. Furthermore, phase combiners 284 can be used to connect the network components 250 of different layers 281 with one another. A spectral phase analyzer 285 can subsequently provide the output 210 on the basis of the output signals of the network components 250.

The above explanation of the embodiments describes the present disclosure exclusively in the context of examples. Of course, individual features of the embodiments can be freely combined with one another, if technically reasonable, without leaving the scope of the present disclosure.

### LIST OF REFERENCE SIGNS

1 transportation vehicle
2 surroundings
100 optical signal
101 input signal
102 output signal
103 sensor data
200 artificial neural network, ANN
210 output
230 element
250 network component
251 neuron
252 weight, weighting
260 crystal
270 interface
280 semiconductor
281 dispersive layer
282 linear frequency modulator
283 optical fiber
284 spectral combiner, phase combiner, grating
285 spectral phase analyzer
290 level
301 first method operation
302 second method operation

1. A method for providing an artificial neural network, the method comprising:
providing an optical signal for the artificial neural network to obtain an output of the artificial neural network by processing of the optical signal by the artificial neural network; and
using a property of the optical signal, which is specific for a spectral phase and/or a temporal phase of the optical signal, to provide at least one network component of the artificial neural network for the processing, wherein the at least one network component comprises at least one neuron and/or one weight of the artificial neural network.

2. The method of claim 1, wherein the provision of the optical signal includes transmission of a light signal into the network component, wherein the light signal is a carrier of an item of information which is processed by the processing of the artificial neural network, to obtain an assessment of the information as the output.

3. The method of claim 1, wherein the use of the property specific for the spectral and/or temporal phase of the optical signal includes changing a spectral phase profile of the optical signal nonlinearly and linearly to change the property, to execute a nonlinear function of the at least one neuron and a linear weighting of the weight.

4. The method of claim 1, wherein the output and/or an output signal of the at least one network component is evaluated in that the property of the optical signal specific for the spectral and/or temporal phase of the optical signal is evaluated.

5. The method of claim 1, wherein the optical signal is provided as an optical input signal, which is specific for an item of input information, and is processed by the at least one network component to obtain an optical output signal specific for the output.

6. The method of claim 1, wherein the plurality of network components including the at least one network component are provided, wherein the plurality of network components which comprise neurons and/or weights, which are provided with one another in different levels of the artificial neural network and are optically connected to one another.

7. The method of claim 1, wherein the property specific for the spectral and/or temporal phase of the optical signal is the spectral and/or temporal phase itself or a group delay or a group delay dispersion or a group velocity dispersion or a third order or higher order dispersion of the derivative of the spectral phase.

8. The method of claim 1, wherein the artificial neural network is used in a transportation vehicle, wherein the optical signal is provided as an optical input signal, which is specific for an item of input information about the surroundings of the transportation vehicle, and is processed by the at least one network component to obtain the output as a classification of the input information.

9. A system for providing an artificial neural network, the system comprising:
an interface for providing an optical signal for the artificial neural network to obtain an output of the artificial neural network by processing of the optical signal by the artificial neural network;
at least one optical element for a use of a property of the optical signal, which is specific for a spectral phase and/or a temporal phase of the optical signal to provide at least one network component of the artificial neural network for the processing,
wherein the at least one network component comprises at least one neuron and/or one weight of the artificial neural network.

10. The system of claim 9, further comprising a plurality of optical elements including the at least one optical element, wherein the plurality of optical elements are each designed to change a spectral phase profile of the optical signal at least nonlinearly for the use of the property to provide an output signal of a neuron of the artificial neural network in each case
at least one spectral combiner of the artificial neural network is provided to spectrally combine output signals of the neurons; and
a spectral phase analyzer provided to evaluate a phase of the combined output signal for the provision of the output.

11. The system of claim 9, wherein the provision of the optical signal includes transmission of a light signal into the network component, wherein the light signal is a carrier of an item of information which is processed by the processing of the artificial neural network, to obtain an assessment of the information as the output.

12. The system of claim 1, wherein the use of the property specific for the spectral and/or temporal phase of the optical signal includes changing a spectral phase profile of the optical signal nonlinearly and linearly to change the property, to execute a nonlinear function of the at least one neuron and a linear weighting of the weight.

13. The system of claim 1, wherein the output and/or an output signal of the at least one network component is evaluated in that the property of the optical signal specific for the spectral and/or temporal phase of the optical signal is evaluated.

14. The system of claim 1, wherein the optical signal is provided as an optical input signal, which is specific for an item of input information, and is processed by the at least one network component to obtain an optical output signal specific for the output.

15. The system of claim 9, further comprising a plurality network components which includes the at least one network component and which comprise neurons and/or weights, which are provided with one another in different levels of the artificial neural network and are optically connected to one another.

16. The system of claim 9, wherein the property specific for the spectral and/or temporal phase of the optical signal is the spectral and/or temporal phase itself or a group delay or a group delay dispersion or a group velocity dispersion or a third order or higher order dispersion of the derivative of the spectral phase.

17. The system of claim 9, wherein the artificial neural network is used in a transportation vehicle, wherein the optical signal is provided as an optical input signal, which is specific for an item of input information about the surroundings of the transportation vehicle, and is processed by the at least one network component to obtain the output as a classification of the input information.
